(19) United States
(12) Patent Application Publication
(10) Pub. No.: US 2004/0158614 A1
(43) Pub. Date: Aug. 12, 2004

(54) Method and apparatus for managing data transmission privileges during a network conference

(76) Inventor: Bruce Williams, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/360,062

(22) Filed: Feb. 6, 2003

(51) Int. Cl. G06F 15/16

(52) U.S. Cl. 709/207; 709/205

(57) ABSTRACT

Apparatus and methods for managing data transmission privileges during a network conference are disclosed. According to one embodiment, the method comprises the steps of enabling at least one participant in a network conference to request data transmission privileges, receiving at a network destination one or more requests for data transmission privileges, assigning a highest priority to the one or more requests, and enabling a participant associated with a request having the highest priority to transmit data for presentation.

### FIELD OF INVENTION

This invention relates generally to network conferencing systems and, more specifically, to methods and apparatus for managing data transmission privileges during network conferences.

### BACKGROUND

Although many face-to-face conferences or meetings still occur today, it is becoming more and more popular for conferences to be held virtually over a network. In a virtual network conference, the participants need not be physically present in the same room but instead may be geographically separated. Typically, each participant will join the network conference by logging onto the network over which the conference will be held via a network device, such as a personal computer. Once all of the participants are logged on, the network conference usually begins.

Just as in face-to-face meetings, it is often desirable, or even necessary, for the participants in a network conference to communicate and share ideas and information with each other. One of the more popular methods for enabling interaction among the participants is through the use of video cameras. The video cameras are usually positioned nearby the network devices being used by the participants during the network conference. The video camera may be used to obtain video stream data and/or voice data of the participant of the network device with which the particular video camera is associated. The video stream data and/or voice data may then be sent from to the other participants.

Although network conferences usually work well, they do have at least one major drawback: During a network conference, it is often the case that more than one participant will attempt to or will transmit data (e.g., voice data, video stream data, image data, textual data, graphical data, etc.) for presentation to the other participants at the same time. When this happens, however, the bandwidth needed for the network conference can substantially increase. Such an increased bandwidth requirement may result in data loss, slow data transfer rates, choppy video data displays, etc., particularly if the network over which the conference is being held is not capable of handling the newly-increased bandwidth requirements. Even if sufficient network bandwidth exists, it may be difficult to understand what is being said if voice data from two or more participants are simultaneously broadcast.

### SUMMARY OF THE INVENTION

A method for managing data transmission privileges during a network conference comprises: Enabling at least one participant in a network conference to request data transmission privileges; receiving at a network destination one or more requests for data transmission privileges; assigning a highest priority to the one or more requests; and enabling a participant associated with a request having the highest priority to transmit data for presentation.

Also disclosed are apparatus and systems for managing data transmission privileges during a network conference. According to one embodiment, the apparatus comprises at least one computer-readable storage media and computer-readable program code stored thereon. The computer-readable program code comprises program code for enabling at least one participant in a network conference to request data transmission privileges; program code for receiving at a network destination one or more requests for data transmission privileges; program code for assigning a highest priority to the one or more requests; and program code for enabling a participant associated with a request having the highest priority to transmit data for presentation.

### BRIEF DESCRIPTION OF THE DRAWING

Illustrative and presently-preferred embodiments of the invention are shown in the accompanying drawing in which:

FIG. 1 is a high level diagram of one embodiment of apparatus for managing data transmission privileges during a network conference according to the present invention;

FIG. 2 is a pictorial representation of a network device that may be used in conjunction with the method and apparatus for managing data transmission privileges of the present invention;

FIG. 3 is a pictorial representation of a first user interface that may appear on the network device with “DROP” and “END” buttons shown as being inaccessible to a user of the network device;

FIG. 4 is a pictorial representation of a second user interface that may appear on the network device with “NEXT” and “END” buttons shown as being inaccessible to a user of the network device;

FIG. 5 is a pictorial representation of a third user interface that may appear on the network device with the “DROP” and “NEXT” buttons shown as being inaccessible to a user of the network device;

FIG. 6 illustrates the relationship among FIGS. 6A-6D; and

FIGS. 6A-6D together form a flow chart showing an illustrative example of an operational sequence for managing data transmission privileges during a network conference.

### DETAILED DESCRIPTION

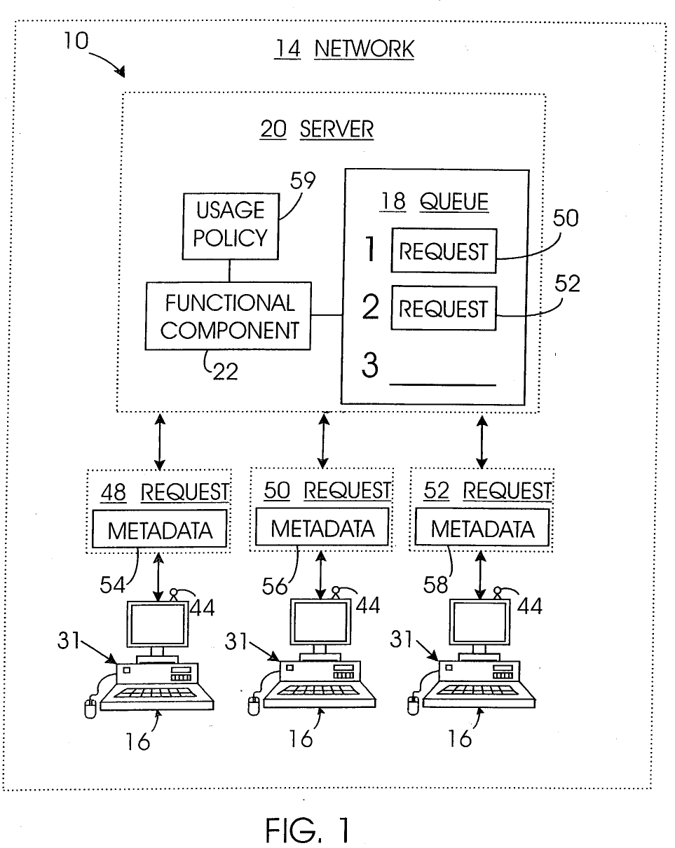

One embodiment of apparatus 10 for managing data transmission privileges during a network conference is best seen in FIG. 1 and may comprise a network 14 for acquiring, processing, directing, and presenting to the various conference participants electronic data relating to the network conference. In the embodiment shown and described herein, the network 14 may comprise a plurality of network devices 16 that are operatively associated with a network server 20. Each network device 16 may be provided with suitable aural (i.e., sound) and visual transducers (e.g., a microphone and a video camera assembly 44) for enabling each network device 16 to capture sound and images and transmit them over the network 14. The apparatus 10 may also comprise a functional component 22 for carrying out the functions and operations of the invention. In the embodiment of FIG. 1, the functional component 22 may comprise computer-readable program code (i.e., software) provided on the network server 20. Alternatively, other arrangements are possible as will be described in greater detail below. In one embodiment, the functional component 22 is operatively associated with a usage policy 59. The usage policy 59 enables the functional component 22 to generate a queue 18 of requests (e.g., 50 and 52) in a manner that also will be further described below.

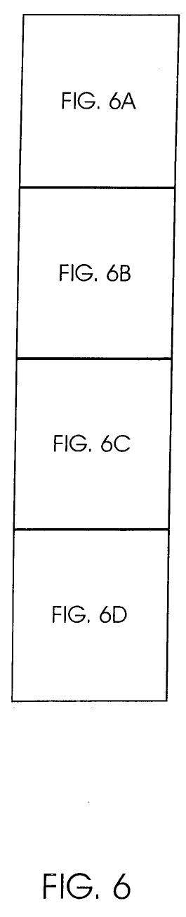

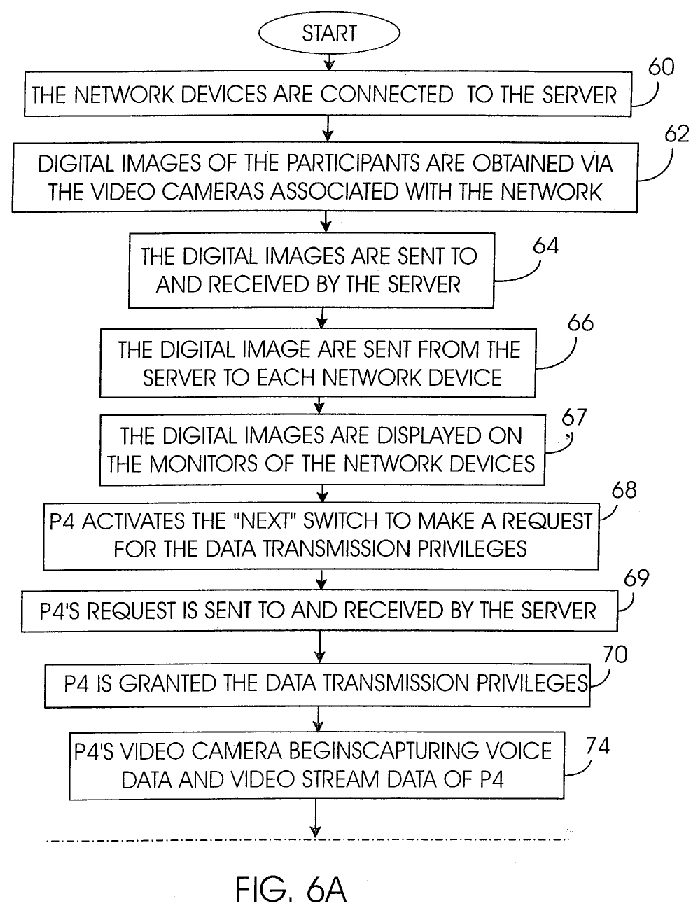

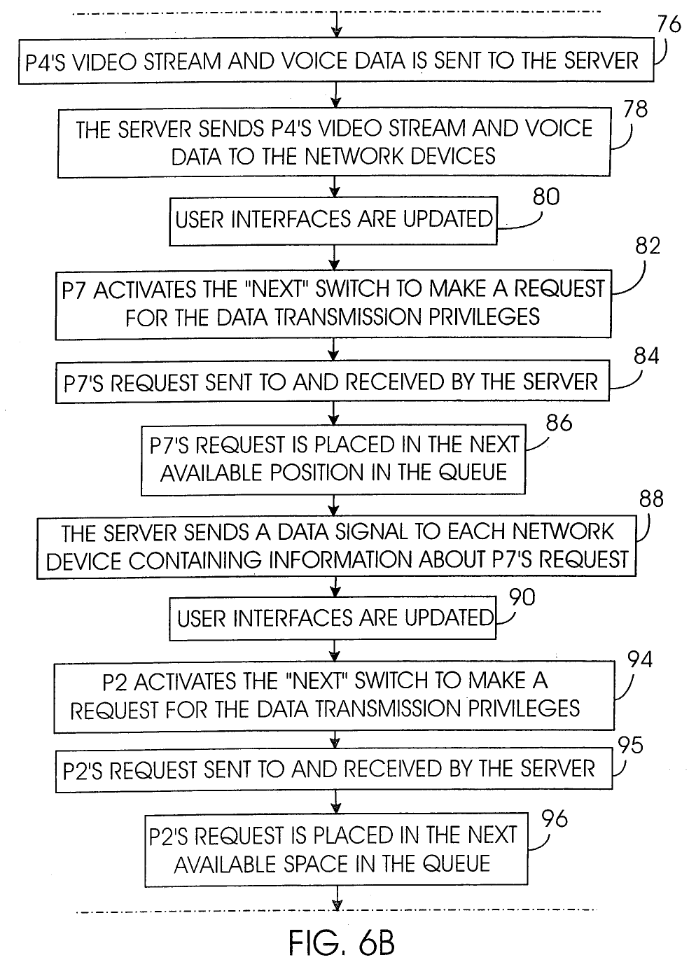

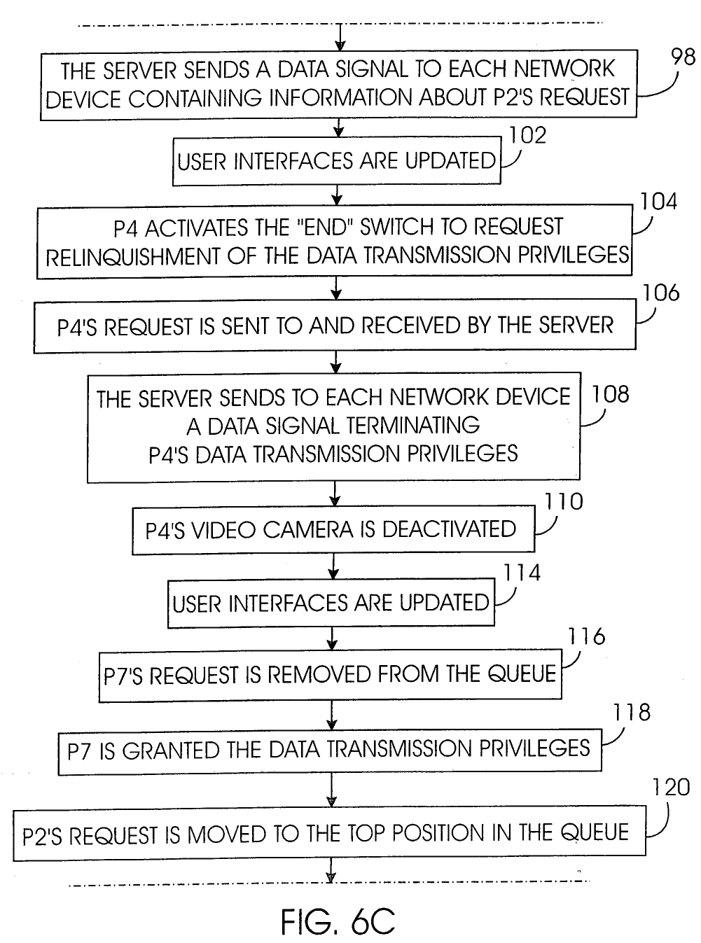

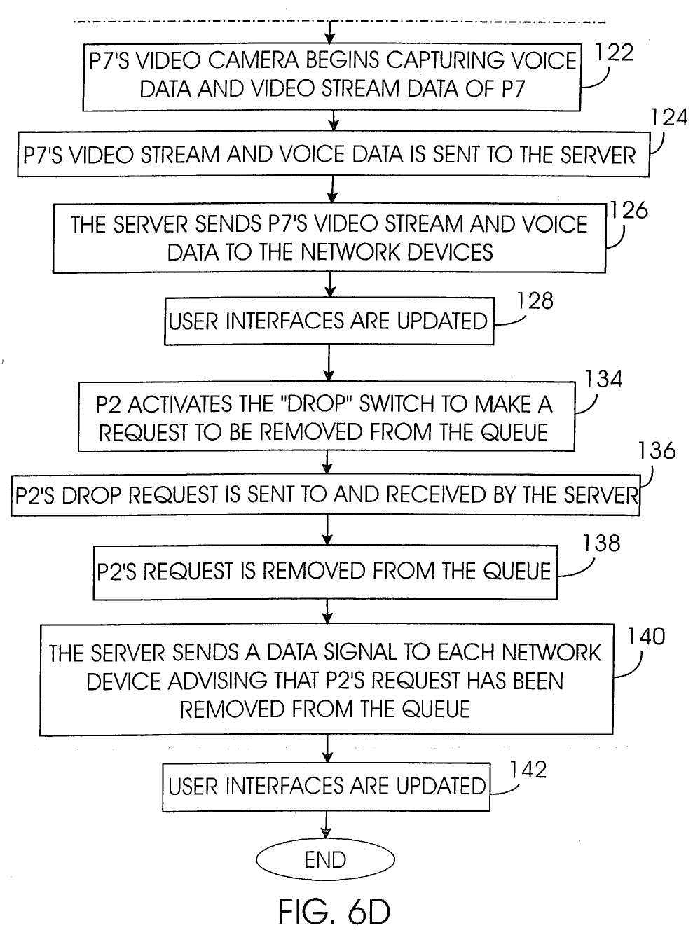

An example of an operational sequence 12 for managing data transmission privileges during a network conference is illustrated in FIGS. 6A-6D. Briefly, methods consistent with the teachings of the present invention that are contained within the illustrative operational sequence 12 shown in FIGS. 6A-6D involve enabling each participant in the network conference to request data transmission privileges by issuing a participation request (e.g., requests 48, 50, and 52) via the network device 16. Embodiments of a system of the present invention then assigns a priority to each participation request (e.g., requests 48, 50, and 52), and enables the participant associated with the request having the highest priority (e.g., participation request 48) to transmit data for presentation to the participants during the network conference. Then, once the selected participant has finished, the next participant is able to proceed.

One advantage of the present invention is that it limits the data transmission privileges to a single participant at any given time during the network conference. That is, only a single participant may transmit data for presentation at a given time during the network conference. By limiting data transmission privileges to a single participant, embodiments of the present invention helps to reduce the bandwidth needed to conduct the network conference. Accordingly, embodiments of the present invention will generally eliminate, or at least reduce, the problems commonly associated with excessive bandwidth requirements, such as data loss, slow data transfer rates, choppy video data displays, etc. Further, by limiting data transmission privileges to a single participant it reduces the confusion likely to occur when more than one conference participant transmits data (e.g., speaks) at the same time.

Embodiments of the invention may be used to provide (e.g., via a display device associated with the network device 16) the order in which participants will be granted data transmission privileges. For example, in one embodiment, the participation requests received by the functional component 22, and ordered or arranged in the queue 18, are displayed for the participants. Thus, each participant may readily determine the order in which the participants will be granted data transmission privileges. The ability for each participant to see the order of data transmission privileges enables each participant to prepare in advance for the presentation and/or data he or she intends to transmit after being granted the data transmission privileges. For example, when a participant is the next in line for the granting of data transmission privileges, that participant may want to be at his or her network device and not be otherwise engaged or absent (e.g., such as getting a cup of coffee, etc.).

Embodiments of the invention may be implemented on a conventional network conferencing system without requiring any hardware changes to the conferencing system. For example, in one preferred embodiment, an embodiment of the invention may be implemented via computer-readable program code installed on the server 20. Alternatively, other arrangements and configurations are possible, as will be discussed in further detail below.

It should be noted that the present invention may be utilized in conjunction with any of a wide range of conferencing systems that are now known in the art or that may be developed in the future. Moreover, the present invention is not limited to conferencing systems having the particular configurations and/or components shown and described herein, but could instead be used in conferencing systems having other configurations and/or component arrangements, as would be obvious to persons having ordinary skill in the art after having become familiar with the teachings of the present invention. Accordingly, the present invention should not be regarded as limited to the particular conferencing systems, configurations, and component arrangements shown and described herein.

With the foregoing considerations in mind, one embodiment of the apparatus or system 10 for managing data transmission privileges during a network conference may comprise a network 14, one or more network devices 16, and a network server 20, as best seen in FIG. 1. In one preferred embodiment, the network 14 comprises the Internet, although this is not required. That is, the network 14 may comprise any of a wide variety of other networks, such as, for example, a local area network (LAN), a wide area network (WAN), an Intranet, the Internet, or some combination thereof. Consequently, the present invention should not be regarded as limited to the particular networks shown and described herein.

The network devices 16 operatively associated with the network 14 enable the various users or conference participants to participate in the network conference. Accordingly, the network devices 16 may comprise any of a wide range of devices and systems that are now known in the art or that may be developed in the future that would be suitable for the particular conferencing system. Moreover, each network device 16 need not be identical to the others, but could instead comprise different systems, as would be obvious to persons having ordinary skill in the art after having become familiar with the teachings of the present invention. Consequently, the present invention should not be regarded as limited to any particular network device 16 or combinations of different types of network devices 16. However, by way of example, in one preferred embodiment, each network device 16 is identical to the others and comprises a personal computer system 31 of the type that are well-known in the art and readily commercially available.

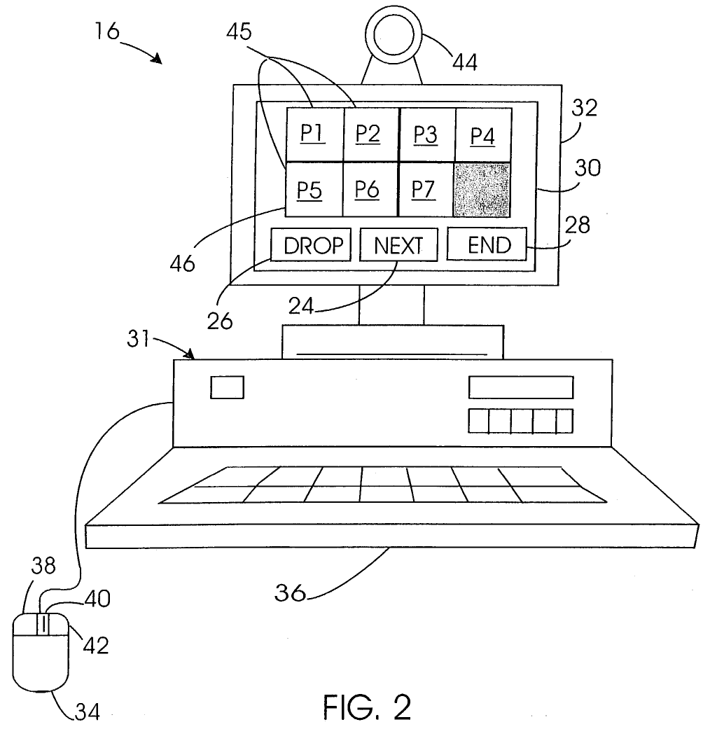

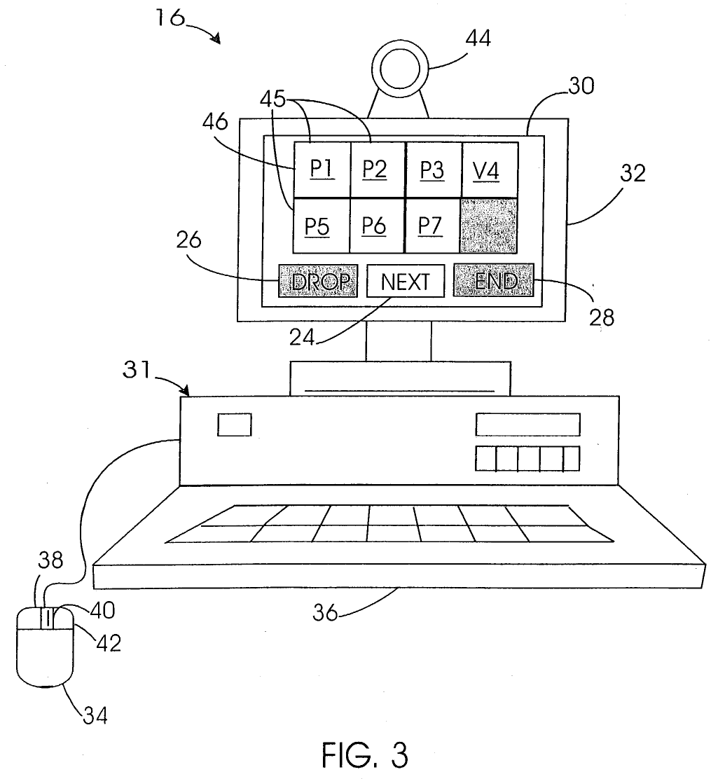

Referring now primarily to FIG. 2, each computer system 31 may be provided with a display device 32, a pointing device, such as a mouse 34, and a keyboard 36. The computer system 31 may also be provided with a suitable device or devices for enabling the network device to capture sounds and/or images so that the same may be transferred to the other network devices 16 operatively associated with the network 14. For example, in one preferred embodiment, each computer system 31 is provided with a combination video camera and microphone assembly 44, although other devices may also be used. However, since network devices for transmitting voice and/or video data over a network are well-known in the art and could be readily provided by persons having ordinary skill in the art after having become familiar with the teachings of the present invention, the network devices 16 that are utilized in one preferred embodiment of the present invention will not be described further herein.

The various network devices 16 may be linked to the network 14 via any suitable means, including but not limited to, a hardwired connection, an infrared connection, a dial-up connection (i.e., using a modem), a dedicated connection (e.g., cable, digital subscriber line (DSL), T-1, T-3, etc.), via satellite, through other networks (e.g., LAN, WAN, Intranet, the Internet, etc.), or through a combination of networks. That is, although the network devices 16 are illustrated in FIG. 1 as being directly connected to the network 14 (i.e., with no intermediary devices between the network devices 16 and the network 14), this need not be the case, and the network devices 16 may be connected or linked to the network 14 via one or more intermediary devices and/or networks. Here again, since systems and methods for connecting network devices to a network are well-known in the art, the particular systems and methods for connecting the various network devices 16 to the network 14 utilized will be readily apparent by persons having ordinary skill in the art.

The network 14 may also be provided with a server 20 that is operatively connected to each of the network devices 16 in the manner best seen in FIG. 1. Alternatively, other arrangements are possible, as would be obvious to persons having ordinary skill in the art after having become familiar with the teachings of the present invention. The server 20 may be provided with a functional component 22 for implementing the functions and operations of the present invention. The functional component 22 may be embodied in hardware, firmware and/or software (i.e., hardware and/or computer-readable program code) provided on the server 20. For example, in one embodiment, the functional component 22 comprises computer-readable program code that is stored in one or more suitable computer-readable storage media (not shown) operatively associated with the server 20. In another arrangement, the computer-readable program code comprising the functional component 22 may reside in a stand-alone device (not shown) that is operatively associated with the network 14, the server 20, or any of the network devices 16, as would be obvious to persons having ordinary skill in the art after having become familiar with the teachings of the present invention. Consequently, the present invention should not be regarded as limited to the particular configurations and system architectures shown and described herein.

It is to be understood that the computer-readable program code described herein can be conventionally programmed using any of a wide range of suitable computer-readable programming languages that are now known in the art or that may be developed in the future. It is also to be understood that the computer-readable program code can include one or more functions, routines, subfunctions, and subroutines, and need not be combined in a single package but may instead be embodied in separate components. In addition, the program code can reside within the server 20 or it can have one or more components that reside at one or more locations on the network 14.

Regardless of the particular configuration and location of the functional component 22, however, the computer-readable program code comprising the functional component 22 may comprise program code for carrying out one or more of the various steps of the methods of the present invention. More specifically, the functional component 22 may comprise program code for creating a queue 18 and ordering one or more requests for data transmission privileges received by the server in the queue 18. The queue 18 may contain a list or record of the pending participation requests (e.g., requests 50 and 52). In other words, the queue 18 may contain a list or record of the participants and/or their requests that are on stand-by status (i.e., waiting to be granted data transmission privileges). Since preferably only a single participant will have the data transmission privileges at a given time, participants who have requests on the queue 18 must wait their turn before being enabled to transmit data for presentation during the network conference when another participant has the data transmission privileges.

To enable for identification of the participant and/or network device 16 that submitted a particular request for the data transmission privileges, each request may have associated therewith suitable metadata, such as a user ID, group ID, originating application, originating network device, a combination thereof, etc. The metadata may be assigned to a request by using suitable program code residing on the server 20, the network devices 16, elsewhere on the network 14. The metadata assigned to a request may be based, at least in part, on the logon of the participant making such request and/or the network device from which the request originated. Alternatively, an administrator may instead assign the metadata. In the embodiment shown and described herein, the requests 48, 50, and 52 have each been assigned metadata 54, 56, and 58, respectively. See FIG. 1.

The manner in which the participants and/or their requests are listed in the queue 18 may vary. For example, in one embodiment, the queue 18 may contain the names of the participants that have made the requests 50, 52 for the data transmission privileges. In another embodiment, the queue 18 may contain some other user ID associated with the participants that have made the requests 50, 52 for the data transmission privileges. In yet another embodiment, the queue 18 may contain the IP addresses of the network devices 16 from which the requests 50, 52 originated. Still yet other means of identifying the participants and/or requests in the queue 18 are possible as would be obvious to one having ordinary skill in the art after having become familiar with the teachings of the present invention.

The functional component 22 may be operatively associated with a usage policy 59. The usage policy 59 provides a rule or rules for granting data transmission privileges based on the participation requests (e.g., 48, 50, and 52). The rule or rules applied by the usage policy 59 may comprise any of a wide range of rules for managing and assigning priority to the various participation requests 48, 50, and 52 and may be fixed or varied, as may be required or desired in any particular application. For example, in one preferred embodiment, the rules of the usage policy 59 enable the functional component 22 to maintain the queue 18 and grant data transmission privileges on a first-in, first-out (FIFO) basis. That is, the queue 18 is maintained such that the apparatus 10 grants to the participants the data transmission privileges on a first-in, first-out (FIFO) basis. By way of example, three participants may at the start of the network conference make requests 48, 50, and 52 for data transmission privileges. If so, the apparatus 10 will grant data transmission privileges to the participant whose request was received by the apparatus 10 first in time, which in FIG. 1 is request 48. The apparatus 10 may then place the requests 50 and 52 on the queue 18 in the order in which those requests 50 and 52 were received by the functional component 22.

When a participant makes a request for the data transmission privileges, the apparatus 10 may place the participant's request at the bottom of the queue 18 if another participant currently has the data transmission privileges. If so, the participant associated with the request on the bottom of the queue 18 must now wait for the other preceding and pending requests to be cleared from the queue 18 before the participant obtains the top position on the queue 18. For example, a request may be removed from the queue 18 if the participant associated with that request is granted the data transmission privileges. Alternatively, a request may also be cleared from the queue 18 if the participant associated with the request activates a “DROP” switch 26 (FIG. 2), as will be explained in greater detail below.

Regardless of how a participant obtains the top position in the queue 18, that participant will be granted the data transmission privileges after the participant currently having the data transmission privileges relinquishes them or has them revoked. In the embodiment shown and described herein, a participant may relinquish data transmission privileges by activating an “END” switch 28 (FIG. 2), as will also be explained in greater detail below. Preferably, the data transmission privileges once granted to a participant are preserved for that participant until the participant relinquishes them. Alternatively, or in addition, data transmission privileges may be revoked from a participant if the participant has had the data transmission privileges for a predetermined amount of time. By providing this optional feature, a participant may be prevented from dominating the data transmission privileges. Data transmission privileges may also be revoked from a participant if the participant has had the data transmission privileges for a predetermined amount of time but the participant has been inactive or idle for that predetermined amount of time. This optional feature may help to avoid, or at least reduce, the time that would otherwise be wasted should a participant having the data transmission privileges leave his or her network device but forget to relinquish the data transmission privileges.

In one embodiment, the apparatus 10 may be configured to grant the data transmission privileges to a particular participant, such as a participant designated as the conference leader or manager or leader, at the start of a network conference. However, this need not be the case. For example, in another embodiment, the apparatus 10 may instead await the arrival of the first request for data transmission privileges before granting any data transmission privileges to a participant.

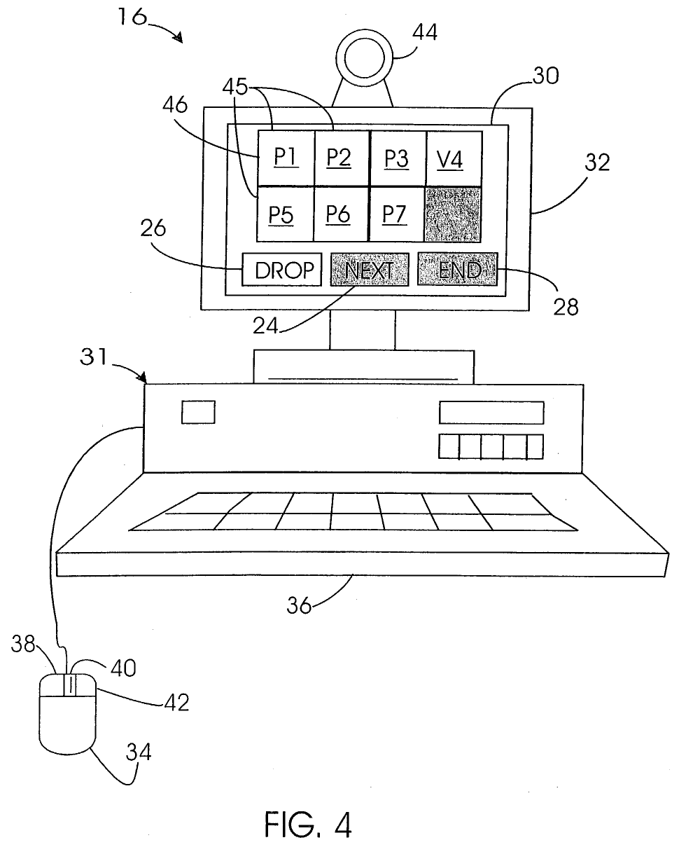

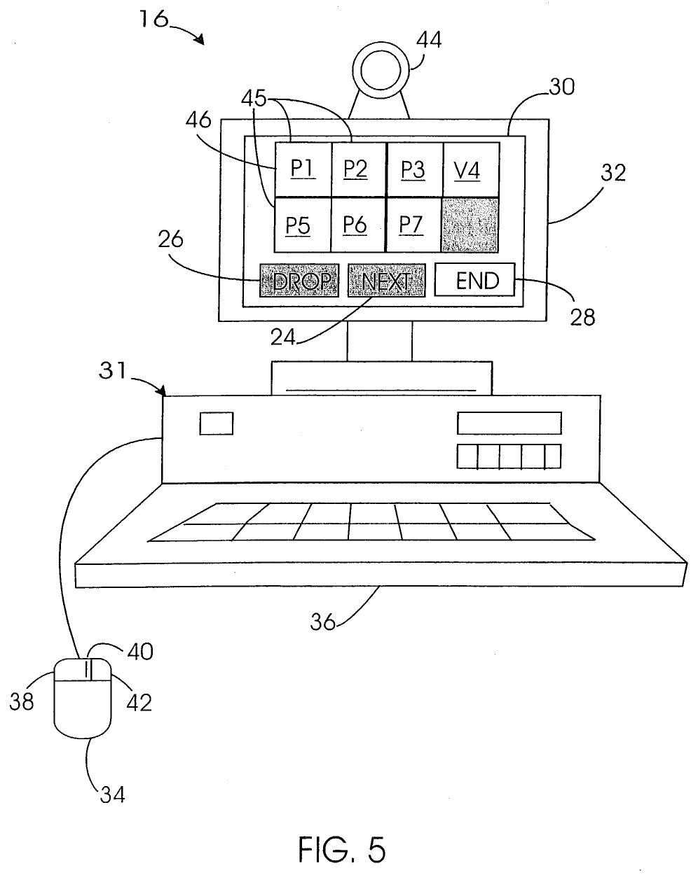

It is generally preferred, although not required, to limit each participant to just one request on the queue 18 at a given time. Thus, the “NEXT” switch 24 may be rendered inaccessible to a participant after his or her request has been placed on the queue 18. See FIG. 4 (inaccessibility being indicated by gray shading). It is also generally preferred, although not required, that the participant having the data transmission privileges not be enabled to have a request on the queue 18. Thus, the “NEXT” switch 24 may be inaccessible to a participant that has been granted the data transmission privileges. See FIG. 5 (inaccessibility being indicated by gray shading). Alternatively, the apparatus 10 may enable the participants to be placed on the queue 18 any number of (i.e., one or more) times.

Other rules may also be defined by the usage policy 59 such that the queue 18 is maintained on other than the FIFO basis. For example, in one embodiment, the later-received request for data transmission privileges from a certain participant (e.g., a participant designated conference leader, etc.) may be afforded more weight and thus be given priority over the earlier-received requests for data transmission privileges from other participants. In such an embodiment, a pass code (not shown) may be included in the metadata (e.g., 54, 56, 58) associated with the conference leader's request that overrides the rules defined in the usage policy 59 and thus may interrupt the previous participant if one existed. The previous participant may then be bumped to or placed at the top of the queue 18. Later, when the conference leader loses the data transmission privileges, for example, by relinquishing them, the previous participant that was interrupted by the conference leader may again resume control of the data transmission privileges.

In short, the usage policy 59 may define any number of (i.e., one or more) suitable rules with such rules being more complex and/or more simple than those described herein. In addition, more than one set of rules can be defined in the usage policy 59, and the apparatus 10 may use more than one usage policy 59 when prioritizing the requests for the data transmission privileges. The usage policies 59 and the rules defined therein may ultimately depend on the various design considerations and protocols for the network conference.

Regardless of what rules are defined in the usage policy 59, the queue 18 may be maintained (i.e., persist) as long as the network conference for which it was created is still underway. Moreover, the queue 18 may be stored and maintained in one or more suitable computer-readable storage media operatively associated with the network 14. In the embodiment shown and described herein, the queue 18 may be stored in one or more suitable computer-readable storage media residing at, or associated with, the server 20. Alternatively, the queue 18 may be stored in one or more suitable computer-readable storage media residing at, or associated with, one or more of the network devices 16, elsewhere on the network 14, a combination thereof, etc. Regardless of where it resides, however, the queue 18 should preferably be accessible to the apparatus 10 at all times during the network conference.

As briefly mentioned earlier, each conference participant may be able to access one or more switches 24, 26, and 28 during the network conference. In one embodiment, the switches 24, 26, and 28 may comprise a portion of a user interface 30 provided on the display device 32 associated with each network device 16 and may represent “NEXT,” “DROP,” and “END” switches, respectively, although other designations may be used. The user interface 30 enables each participant to interact with the other participants during the network conference. More specifically, and as shown in FIGS. 2 through 5, each user interface 30 may be identical to the others, although this is not required, and may comprise a graphical user interface provided on the display device 32 associated with each network device 16.

The first, second, and third (e.g., “NEXT,” “DROP,” and “END”) switches 24, 26, and 28 may be implemented as user-selectable icons or dialog boxes in the manner best seen in FIGS. 2-5. Each of the switches 24, 26, 28 may be selected or activated by a participant via an appropriate input device (e.g., the mouse 34, the keyboard 36, etc.) associated with the corresponding network device 16. For example, a participant who does not have a request on the queue 18 nor have the data transmission privileges should be able to access (i.e., activate) the first or “NEXT” switch 24 but not the second and third switches 26 or 28. This may be accomplished by inactivating (e.g., by “graying out”) the other switches (e.g., the “DROP” and “END” switches 26 and 28) in the manner illustrated in FIG. 3. In addition, it is generally preferred, but not required, that a participant who has a request on the queue 18 should be able to access (i.e., activate) the second or “DROP” switch 26 but not the first and third switches 24 or 28. Again, this may be accomplished by inactivating (e.g., “graying-out”) the other switches (e.g., the “NEXT” and “END” switches 24 and 28) in the manner illustrated in FIG. 4. It is also generally preferred, but not required, to enable a participant having the data transmission privileges to access (i.e., activate) the third or “END” switch 28 but not the first and second (e.g., the “NEXT” and “DROP”) switches 24 and 26. See FIG. 5 (gray shading indicating inaccessibility).

Alternatively, other ways of implementing the first, second, and third switches 24, 26, and 28 are possible as would be obvious to persons having ordinary skill in the art after having become familiar with the teachings of the present invention. For example, in another embodiment, the mouse 34 may be configured such that activation of a left mouse button 38 activates the first switch 24, activation of a scrolling wheel 40 activates the second switch 26, and activation of a right mouse button 42 activates the third switch 28.

In addition to displaying the first, second, and third (e.g., “NEXT,” “DROP,” and “END”) switches 24, 26, and 28, the user interface 30 may also be used to identify each of the conference participants (e.g., P1, P2, P3, P4, P5, P6, P7, etc.). In the embodiment shown and described herein, each user interface 30 may display digital images (e.g., images 45) of the conference participants. The digital images 45 may be obtained by way of the video cameras 44 associated with each of the network devices 16. The digital images 45 may also be obtained through other means. For example, a participant may use a scanner or digital camera to provide the participant's digital images 45. Still other configurations are possible. For example, in another embodiment, other information, besides information about the particular conference participant, may be displayed on the user interface 30. For example, if a given conference participant wishes to discuss a document, that conference participant may desire to have the document displayed on the user interfaces 30 of the various network devices 16 so that the document may be more easily discussed. The image of the document may be displayed in the place of the image of the particular conference participant having data transmission privileges. Alternatively, the document may comprise a large portion, or even substantially the entirety, of the user interfaces 30 in order to provide enhanced readability of the document. Still other arrangements are possible, as would be obvious to persons having ordinary skill in the art after having become familiar with the teachings of the present invention. Consequently, the present invention should not be regarded as limited to the particular display options and formats shown and described herein.

Regardless of how the digital images 45 are acquired, the digital images 45 may be displayed in a matrix 46 (i.e., in rows and columns) on the user interface 30. See FIG. 2. Although the gray shaded portion or area of matrix 46 represents an unused portion of the matrix 46, it should be understood that the matrix 46 is not be limited to the 2-row, 4-column matrix shown in FIG. 2. Indeed, any suitable matrix may be used in its entirety or in part to display the digital images 45. Alternatively, other display formats and other means of identifying the various participants are possible as would be obvious to one having ordinary skill in the art after having become familiar with the teachings of the present invention. For example, in an alternative embodiment, the participants' names may be displayed on the user interface 30.

In addition to obtaining the digital images of the participants, the video cameras 44 may also be used to capture video stream and voice data of the participants. For example, if the participant P4 currently has the data transmission privileges, the video camera 44 associated with the network device 16 being used by participant P4 may be used to capture video stream data and voice data of participant P4, which as explained in greater detail below, may be displayed on the user interfaces 30 associated with each network device 16. More specifically, the video stream data (shown in FIGS. 3-5 as V4) may replace the digital image of the participant P4 in the matrix 46. Alternatively, other display formats for the video stream data are possible as would be obvious to persons having ordinary skill in the art after having become familiar with the teachings of the present invention.

The user interface 30 may also be used to display the queue 18. More specifically, the identity of the participants that have made requests for the data transmission privileges and the order in which those participants will be granted data transmission privileges may be provided to the participants via the user interfaces 30. For example, in one embodiment, a reference number (not shown) may be placed adjacent the digital image (e.g., 45) of each participant that has a pending request for the data transmission privileges on the queue 18, with the reference number indicating the particular position on the queue 18 (e.g., 1, 2, 3, etc.).

Alternatively, the means (e.g., digital images 45) used to identify the various conference participants may be rearranged or shuffled within the matrix 46 so that their arrangement corresponds to the order in which they are listed in the queue 18. Still yet other means for displaying the queue 18 are also possible as would be obvious to one having ordinary skill in the art after having become familiar with the teachings of the present invention.

An example of an operational sequence 12 for managing data transmission privileges during a network conference is illustrated in FIGS. 6A-6D and involves methods of the present invention. Briefly, the methods of the present invention that are contained within the illustrative operational sequence 12 shown in FIGS. 6A-6D involve enabling each participant in the network conference to request data transmission privileges by issuing a participation request (e.g., requests 48, 50, and 52) via the network device 16. The system of the present invention then assigns a priority to each participation request (e.g., requests 48, 50, and 52), and enables the participant associated with the request having the highest priority (e.g., participation request 48) to transmit data for presentation to the participants during the network conference. Then, once the selected participant has finished, the method enables the next participant to proceed.

During a network conference, the apparatus 10 according to one embodiment may be operated in accordance with the operational sequence 12 shown in FIGS. 6A-D. It should be noted that the operational sequence 12 shown in FIGS. 6A-6D is illustrative only of one particular operational sequence possible with the present invention and should not be regarded as the only operational sequence of conducting a conference according to the present invention.

With reference now to FIG. 6A, a first step 60 of operational sequence 12 may comprise connecting or linking each of the network devices 16 to the server 20, if they are not already so connected. In one embodiment, each of the network devices 16 may be connected to the server 20 by using a socket connection and by using the unallocated ports of the network devices 16.

After the connection between the various network devices 16 and the server 20 has been established, the video cameras 44 may be used to capture digital images (e.g., 45) of the various conference participants (e.g., P1, P2, P3, P4, P5, P6, and P7) at step 62. In the next step 64, the network devices 16 may send the digital images (e.g., images 45) to the server 20. At step 66, the server 20 may send the digital images 45 of the various conference participants to the network devices 16 so that each network device 16 may display the matrix 46 of digital images 45 on the user interface 30 at step 67. See FIG. 2.

At step 68, a conference participant (e.g., conference participant P4) may activate the first switch 24 (e.g., the “NEXT” switch) and thus make a request (e.g., 48, FIG. 1) for data transmission privileges. The participation request 48 of conference participant P4 may be sent to the server for processing at step 69. As explained earlier, the apparatus 10 may read and analyze the metadata (e.g., 54, FIG. 1) associated with the participation request 48 of conference participant P4 to determine that conference participant P4 is the participant that submitted the request (e.g., 48). Assuming now that P4's request (e.g., 48) was received by the apparatus 10 first in time, step 70 may comprise the apparatus 10 granting the data transmission privileges to conference participant P4. After conference participant P4 has been granted the data transmission privileges, the video camera 44 associated with P4's network device 16 may be activated and begin taking video stream data and voice data of conference participant P4 at step 74. Alternatively, and was described above, the conference participant P4 may instead choose to place data other than video stream data on the network. For example, if conference participant P4 is discussing a document, conference participant P4 may elect to have the document transmitted over the network so that the document being discussed appears on the user interfaces of the other conference participants. The document being discussed may appear on the user interface in the position of the image for conference participant P4. Alternatively, the document may be displayed on the entirety, or substantially the entirety, of the user interface so that it appears larger.

Referring now to FIG. 6B, the video stream data and voice data of conference participant P4 may be sent at step 76 from P4's network device 16 to the server 20. At step 78, the server 20 may then send the video stream data and voice data of conference participant P4 to each of the network devices 16 so that each network device 16 may update its user interface 30 at step 80. More specifically, the digital image of conference participant P4 may be replaced by video stream data (shown in FIGS. 3-5 as V4) of conference participant P4. In addition, the user interface 30 of conference participant P4 may be further updated so that the first and second (e.g., “NEXT” and “DROP”) switches 24, 26 are rendered inaccessible (e.g., “grayed-out”). However, the third switch 28 (e.g., the “END” switch) may remain accessible. See FIG. 5.

In the next step 82 (FIG. 6B), another conference participant (e.g., conference participant P7) may make a request (e.g., request 50, FIG. 1) for the data transmission privileges. As explained earlier, conference participant P7 may make the request (e.g., 50) by selecting the first or “NEXT” switch 24 displayed on the user interface 30 associated with the network device 16 of conference participant P7. The “NEXT” switch 24 may be selected by the appropriate activation of the mouse 34 or keyboard 36, as the case may be. The request 50 of conference participant P7 may then be sent to and received by the server 20 at step 84. Upon receipt thereof, the server 20 at step 86 may place the request 50 of conference participant P7 in the next available position on the queue 18, in this case the next or top position. See FIG. 1. At step 88, the server 20 may send a data signal to each of the network devices 16 that informs the network devices 16 of the request 50 of conference participant P7 and its respective placement in the queue 18 so that each network device 16 may update its user interface 30 at step 90. More specifically, the matrix 46 displayed on each user interface 30 may be updated to show the placement of P7's request on the queue 18. For example, in one embodiment, the digital image associated with conference participant P7 may be highlighted (not shown). Additionally, or alternatively, the reference number 1 (not shown) may be positioned adjacent the digital image of conference participant P7 to indicate that conference participant P7 is in the first or top position of the queue 18. In addition, the user interface 30 of conference participant P7 may be updated so that the first and third (e.g., the “NEXT” and “END”) switches 24 and 28 are rendered inaccessible (e.g., “grayed-out”). The second (e.g., “DROP”) switch 26 may remain accessible. See FIG. 4.

While conference participant P4 has the data transmission privileges and P7's request 50 is at the top of the queue 18, another participant (e.g., conference participant P2) may make a request (e.g., request 52) for the data transmission privileges at step 94. The request 52 of conference participant P2 may then be sent to and received by the server 20 (step 95). Upon receipt of the request 52 of conference participant P2, the server 20 may at step 96 place the request 52 of conference participant P2 in the next available place on the queue 18, in this case the second position. See FIG. 1.

Referring now to FIG. 6C, the server 20 may at step 98 send a data signal to each of the network devices 16 that informs the network devices 16 of the request 52 of conference participant P2 and its respective placement in the queue 18. In response, each network device 16 may update its user interface 30 at step 102. For example, in one embodiment, the reference number 2 (not shown) may be positioned adjacent the digital image of conference participant P2 to indicate that conference participant P2 is in the second position of the queue 18. In addition, the user interface 30 of conference participant P2 may be updated so that the first and third (e.g., the “NEXT” and “END”) switches 24 and 28 are rendered inaccessible. The second (e.g., the “DROP”) switch 26 may remain accessible. See FIG. 4.

At step 104 (FIG. 6C), conference participant P4 may make a request for relinquishment of the data transmission privileges by activating the third (e.g., “END”) switch 28 displayed on the user interface 30 of the network device 16 of conference participant P4. The relinquishment request of conference participant P4 may be sent to and received by the server 20 at step 106. Upon receipt of P4's relinquishment request, the server 20 may send (step 108) to each network device 16 a data signal effectively terminating the data transmission privileges of conference participant P4. Upon receipt of the server's 20 data signal, P4's video camera 44 is deactivated at step 110 and thus stops capturing the video stream data and voice data of conference participant P4. In addition, each network device 16 may update its user interface 30 at step 114. More specifically, the digital image of conference participant P4 may be reinserted into the matrix 46 (see FIG. 2) at the position formerly occupied by the video stream data of participant P4 (illustrated in FIGS. 3-5 as V4). In addition, the user interface 30 of the network device 16 of conference participant P4 may be further updated so that the first (e.g., “NEXT”) switch 24 is again the only accessible switch out of the three switches 24, 26, and 28.

Since conference participant P7 was positioned at the top of the queue 18, P7's request (e.g., request 50) may be removed from the queue 18 at step 116. Next, the apparatus 10 may grant conference participant P7 the data transmission privileges at step 118. Now that the request 50 of conference participant P7 no longer occupies the top position in the queue 18, the request 52 of conference participant P2 is moved to the top of the queue 18 (step 120).

Referring now to FIG. 6D, the video camera 44 associated with P7's network device 16 may (step 122) be activated and begin taking video stream data and voice data of conference participant P7. The video stream and voice data of participant P7 may be sent at step 124 from P7's network device 16 to the server 20. At step 126, the server 20 may send the video stream data and voice data of conference participant P7 to each of the network devices 16 so that each network device 16 may update its user interface 30 at step 128 in the manner already described for the other conference participants. That is, the digital image of conference participant P7 may be replaced in the matrix 46 with the video stream data and voice data of conference participant P7. In addition, the reference number positioned adjacent the digital image of conference participant P2 may be changed to 1 from 2 to reflect the upward movement of the request 52 of conference participant P2 from the second to the first position in the queue 18. Finally, P7's user interface 30 may be updated so that the first and second (e.g., “NEXT” and “DROP”) switches 24, 26 are rendered inaccessible. The third (e.g., “END”) switch 28 may be made accessible.

If conference participant P2 wants his or her request 52 to be removed from the queue 18 prior to conference participant P2 being granted the data transmission privileges, P2 may activate the second or “DROP” switch 26 at step 134. P2's drop request may be sent to and received by the server at step 136. In response thereto, the server 20 may remove P2's request 52 from the queue 18 at step 138. Next, the server 20 may send at step 140 a data signal to each network device 16 informing the network devices 16 that the request 52 of conference participant P2 has been removed from the queue 18. At step 142, each network device 16 may update its user interface 30. More specifically, in one embodiment, the user interfaces 30 may be updated so that no reference number appears adjacent the digital image of conference participant P2. In addition, the user interface 30 of conference participant P2 may be updated so that the first (e.g., “NEXT”) switch 24 is again accessible and so that the second and third (e.g., “DROP” and “END”) switches 26 and 28 are not.

It is contemplated that the inventive concepts herein described may be variously otherwise embodied and it is intended that the appended claims be construed to include alternative embodiments of the invention except insofar as limited by the prior art.

What is claimed is:

1. A method, comprising:
enabling at least one participant in a network conference to request data transmission privileges;
receiving at a network destination one or more requests for data transmission privileges;
assigning a highest priority to said one or more requests for data transmission privileges; and
enabling a participant associated with a request having the highest priority to transmit data for presentation.

2. The method of claim 1, further comprising providing to one or more participants the data for presentation transmitted by the participant associated with the request having the highest priority.

3. The method of claim 1, wherein enabling at least one participant in a network conference to request data transmission privileges comprises providing a user interface that is operatively associated with a network device being used by said at least one participant, said user interface comprising a user-selectable switch that when activated makes a request for data transmission privileges.

4. The method of claim 1, wherein enabling a participant associated with the request for highest priority to transmit data for presentation comprises granting data transmission privileges to said participant so that said participant is the only participant able to transmit data for presentation while said participant has the data transmission privileges.

5. The method of claim 4, further comprising enabling said participant to relinquish the data transmission privileges.

6. The method of claim 5, wherein enabling said participant to relinquish the data transmission privileges comprises providing a user interface that is operatively associated with a network device being used by said participant, said user interface comprising a user-selectable switch that when activated makes a request for relinquishment of the data transmission privileges.

7. The method of claim 4, wherein the data transmission privileges are preserved for said participant until relinquished by said participant.

8. The method of claim 4, wherein the data transmission privileges are preserved for said participant until revoked.

9. The method of claim 1, wherein assigning a highest priority to said one or more requests is based at least in part on a usage policy.

10. The method of claim 1, wherein assigning a highest priority to said one or more requests comprises assigning the highest priority to the request that is received by said network destination first in time.

11. The method of claim 1, further comprising identifying one or more participants of the network conference.

12. The method of claim 11, wherein identifying one or more participants of the network conference comprises displaying one or more digital images of said one or more participants.

13. The method of claim 12, further comprising replacing the digital image of the participant enabled to transmit data for presentation with at least a portion of the data for presentation transmitted by said participant.

14. The method of claim 1, further comprising:
assigning metadata to said one or more requests; and
reading the metadata.

15. The method of claim 1, further comprising ordering said one or more requests in a queue.

16. The method of claim 15, further comprising removing a request from said queue.

17. The method of claim 16, wherein removing a request from said queue comprises providing a user interface comprising a user-selectable switch that when activated makes a request for said participant's request to be removed from said queue.

18. The method of claim 15, wherein ordering said one or more requests in a queue is based at least in part on a first-in, first-out basis.

19. The method of claim 15, further comprising displaying said queue to one or more participants of the network conference.

20. The method of claim 1, further comprising:
using a video camera to obtain video stream data of the participant enabled to transmit data for presentation; and
providing said video stream data to one or more participants of the network conference.

21. Apparatus, comprising:
one or more computer-readable storage media;
computer-readable program code stored on said one or more computer-readable storage media, said computer-readable program code comprising:
program code for enabling at least one participant in a network conference to request data transmission privileges;
program code for receiving at a network destination one or more requests for data transmission privileges;
program code for assigning a highest priority to said one or more requests; and
program code for enabling a participant associated with a request having the highest priority to transmit data for presentation.

22. The apparatus of claim 21, wherein said computer-readable program code further comprises program code for ordering said one or more requests in a queue.

23. The apparatus of claim 21, wherein said program code for enabling at least one participant in a network conference to request data transmission privileges comprises program code for providing a user interface comprising a user-selectable switch that when activated makes a request for data transmission privileges.

24. The apparatus of claim 21, wherein said program code for enabling a participant associated with the request having the highest priority to transmit data for presentation comprises program code for granting data transmission privileges to said participant so that said participant is the only participant able to transmit data for presentation while said participant has the data transmission privileges.

25. A system, comprising:
a server for hosting a network conference;
one or more network devices operatively associated with said server, said one or more network devices being used by one or more participants of the network conference;
one or more display devices operatively associated with said one or more network devices;
one or more computer-readable storage media operatively associated with said system;
computer-readable program code stored on said one or more computer-readable storage media, said computer-readable program code comprising:
program code for enabling said one or more participants to request data transmission privileges;
program code for receiving at said server one or more requests for data transmission privileges;
program code for assigning a highest priority to said one or more requests; and
program code for enabling a participant associated with a request having the highest priority request to transmit data for presentation.

26. The system of claim 25, further comprising one or more user interfaces operatively associated with said one or more network devices, said one or more user interfaces comprising:
a first user-selectable switch that when activated makes a request for data transmission privileges;
a second-user selectable switch that when activated makes a request for retraction of a request for data transmission privileges; and
a third user-selectable switch that when activated makes a request for the relinquishment of data transmission privileges.

27. The system of claim 25, further comprising one or more video cameras operatively associated with said one or more network devices, and wherein said computer-readable program code further comprises:
program code for activating the video camera operatively associated with the network device being used by the participant enabled to transmit data for presentation so that said video camera obtains video stream data of said participant; and
program code for providing said video stream data to said one or more network devices.

28. The system of claim 25, wherein said computer-readable program code further comprises program code for ordering said one or more requests in a queue.

29. The system of claim 28, wherein said computer-readable program code further comprises program code for displaying said queue on said one or more display devices.

30. The system of claim 25, wherein said program code for enabling a participant associated with the request having the highest priority comprises program code for granting data transmission privileges to said participant so that said participant is the only participant able to transmit data for presentation while said participant has the data transmission privileges.

31. Apparatus, comprising:
means for enabling at least one participant in a network conference to request data transmission privileges;
means for receiving one or more requests for data transmission privileges;
means for assigning a highest priority to said one or more requests; and
means for enabling a participant associated with a request having the highest priority to transmit data for presentation.

32. A method, comprising:
coupling a server to one or more network devices, said server hosting a network conference, said one or more network devices being usable by one or more participants of the network conference; and
enabling said one or more participants to negotiate for data transmission privileges so that only a single participant may transmit data for presentation at a given time during the network conference.
